(19) United States
(12) Patent Application Publication
(10) Pub. No.: US 2026/0147475 A1
(43) Pub. Date: May 28, 2026

(54) WEARABLE ELECTRONIC DEVICE THAT IDENTIFIES USER INPUT IN EXTERNAL ELECTRONIC DEVICE AND CONTROL METHOD THEREOF

(71) Applicant: SAMSUNG ELECTRONICS CO., LTD., Suwon-si (KR)

(72) Inventors: Hyerim BAE, Suwon-si (KR); Changryong HEO, Suwon-si (KR); Byounguk YOON, Suwon-si (KR); Junyoung CHOI, Suwon-si (KR)

(21) Appl. No.: 19/401,872

(22) Filed: Nov. 26, 2025

Related U.S. Application Data
(63) Continuation of application No. PCT/KR2024/007329, filed on May 29, 2024.

(30) Foreign Application Priority Data
Jun. 1, 2023 (KR) 10-2023-0071157
Jun. 29, 2023 (KR) 10-2023-0084522

(51) Int. Cl. G06F 3/04886; G06F 3/01; G06F 3/03; G06F 3/04842; G06F 3/04845; G06V 10/56; G06V 20/20; G06V 20/52; G06V 40/20

(52) U.S. Cl. CPC G06F 3/04886; G06F 3/011; G06F 3/0317; G06F 3/04842; G06F 3/04845; G06V 10/56; G06V 20/52; G06V 40/28; G06F 2203/04803; G06F 2203/04806; G06V 20/20; G06V 2201/02

(57) ABSTRACT

A wearable electronic device includes a camera, a display, a memory, and at least one processor operably connected to the camera, the display, and the memory. The at least one processor can execute instructions stored in the memory to cause the wearable electronic device to: obtain, from an image captured by the camera, a code image corresponding to a keyboard displayed on an external electronic device, obtain key information corresponding to each of a plurality of keys included in the keyboard, based on the code image, in response to detecting a selection of a key from the keyboard, based on the image captured by the camera, identify key information corresponding to the selected key, and perform the operation corresponding to the selected key on the basis of the identified key information.

### CROSS-REFERENCE TO RELATED APPLICATIONS

This application is a continuation application under, 35 U.S.C. § 111(a), of International Patent Application No. PCT/KR2024/007329, filed on May 29, 2024, which claims priority to Korean Patent Application No. 10-2023-0071157, filed on Jun. 1, 2023, and Korean Patent Application No. 10-2023-0084522, filed on Jun. 29, 2023, the content of which in their entirety is herein incorporated by reference.

### BACKGROUND

### 1. Field

Embodiments of the disclosure relate to a wearable electronic device for identifying a user input from an external electronic device, and a method for controlling the same.

### 2. Description of Related Art

The variety of services and additional functions provided by electronic devices, such as portable electronic devices like smartphones, is steadily increasing. To enhance the utility of these electronic devices and satisfy diverse needs of various users, communication service providers and electronic device manufacturers are competitively developing electronic devices by offering a wide range of functions and differentiating themselves from other companies. As a result, various functions provided through electronic devices are also becoming increasingly sophisticated.

The variety of services and additional functions provided by wearable electronic devices, such as augmented reality (AR) glasses, virtual reality (VR) glasses, and head-mounted display (HMD) devices, is steadily increasing. To enhance the utility of these electronic devices and satisfy the diverse needs of various users, communication service providers and electronic device manufacturers are competitively developing electronic devices by offering a wide range of functions and differentiating themselves from other companies. As a result, various functions provided through wearable electronic devices are also becoming increasingly sophisticated.

When worn on a user's head, AR glasses or VR glasses may provide a realistic experience to the user by displaying virtual images. AR glasses or VR glasses may replace the usability of smartphones in various fields, such as game entertainment, education, or social networking service (SNS). Users may receive smartphone content and/or content similar to reality through AR glasses or VR glasses worn on their heads.

### SUMMARY

According to an embodiment, a wearable electronic device includes a camera, a display, a memory, and at least one processor including processing circuitry operatively connected to the camera, the display, and the memory.

According to an embodiment, the memory stores instructions that, when executed by the at least one processor, individually or collectively, cause the wearable electronic device to obtain, from an image captured by the camera, a code image corresponding to a keyboard displayed on an external electronic device, and obtain key information corresponding to each of a plurality of keys included in the keyboard, based on the code image.

According to an embodiment, in response to detecting a selection of a key from the keyboard, based on the image captured by the camera, key information corresponding to the selected key is identified, and an operation corresponding to the selected key is performed based on the identified key information.

According to an embodiment, a method for controlling a wearable electronic device includes obtaining, from an image captured by a camera of the wearable electronic device, a code image corresponding to a keyboard displayed on an external electronic device, and obtaining key information corresponding to each of a plurality of keys included in the keyboard, based on the code image. The method also includes, in response to detecting a selection of a key from the keyboard, based on the image captured by the camera, identifying key information corresponding to the selected key. The method further includes performing an operation corresponding to the selected key based on the identified key information.

According to an embodiment, a computer program product includes a non-transitory computer-readable storage medium storing instructions configured to be executed by at least one processor of a wearable electronic device to perform a plurality of operations that include obtaining, from an image captured by a camera of the wearable electronic device, a code image corresponding to a keyboard displayed on an external electronic device, and obtaining key information corresponding to each of a plurality of keys included in the keyboard, based on the code image. The operations also include, in response to detecting a selection of a key from the keyboard, based on the image captured by the camera, identifying key information corresponding to the selected key. The operations further include performing an operation corresponding to the selected key based on the identified key information.

### BRIEF DESCRIPTION OF DRAWINGS

The above and other exemplary embodiments, advantages and features of this disclosure will become more apparent by describing in further detail exemplary embodiments thereof with reference to the accompanying drawings, in which:

FIG. 1 is a block diagram illustrating an electronic device in a network environment according to an embodiment.

FIG. 2 is a perspective view illustrating internal components of a wearable electronic device according to an embodiment.

FIG. 3A is a front view illustrating a wearable electronic device according to an embodiment.

FIG. 3B is a rear view illustrating a wearable electronic device according to an embodiment.

FIG. 4 is another perspective view illustrating a wearable electronic device according to an embodiment.

FIG. 5 is a diagram illustrating an operation of identifying a user input from an external electronic device by an electronic device according to an embodiment.

FIG. 6 is a flowchart illustrating an operation of identifying a user input from an external electronic device by an electronic device according to an embodiment.

FIG. 7 is a diagram illustrating a keyboard screen displayed on an external electronic device according to an embodiment.

FIG. 8 is a diagram illustrating a user input operation through a keyboard screen displayed on an external electronic device according to an embodiment.

FIG. 9A is a diagram illustrating an operation of displaying a color indicator based on a user input on a keyboard screen displayed on an external electronic device according to an embodiment.

FIG. 9B is a diagram illustrating an operation of displaying a color indicator based on a user input on a keyboard screen displayed on an external electronic device according to an embodiment.

FIG. 10 is a diagram illustrating a keyboard screen of an external electronic device displayed on a virtual reality screen of an electronic device according to an embodiment.

FIG. 11 is a flowchart illustrating an operation of identifying a user input by an electronic device and an external electronic device according to an embodiment.

FIG. 12 is a diagram illustrating a magnified keyboard screen of an external electronic device displayed on a virtual reality screen of an electronic device according to an embodiment.

FIG. 13 is a diagram illustrating an operation of displaying a virtual keyboard, when an external electronic device disappears from a screen of an electronic device due to rotation of the electronic device according to an embodiment.

### DETAILED DESCRIPTION

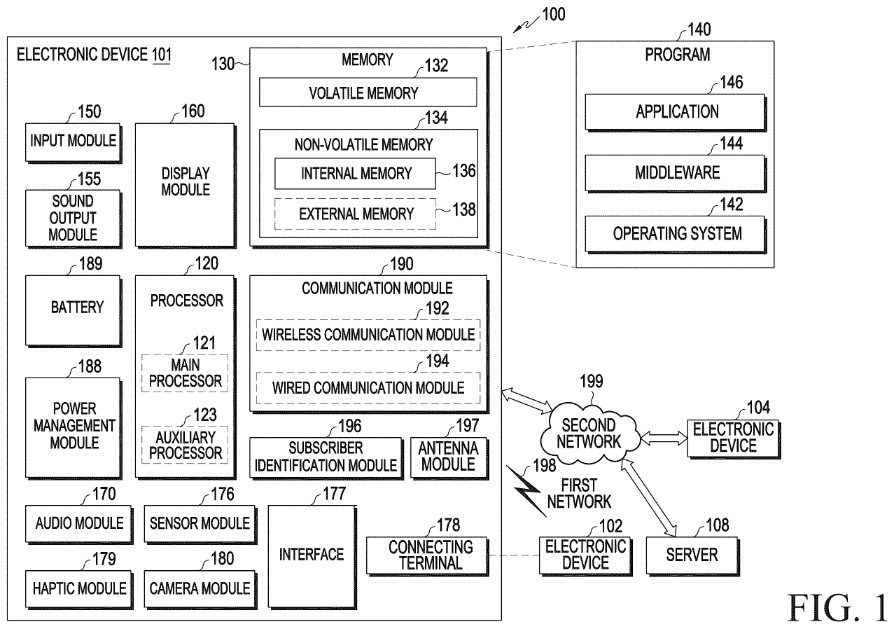

FIG. 1 is a block diagram illustrating an electronic device 101 in a network environment 100 according to embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the strength of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the at least one selected antenna. According to an embodiment, another component (e.g., a radio frequency integrated circuit (RFIC)) other than the radiating element may be additionally formed as part of the antenna module 197.

According to an embodiment, the antenna module 197 may form an mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

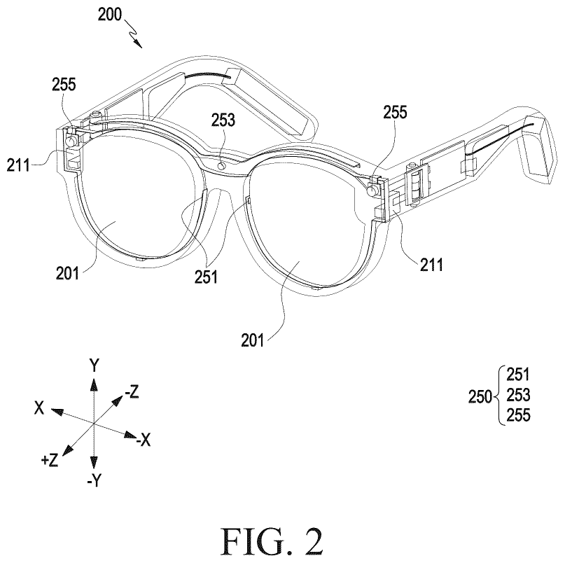

FIG. 2 is a perspective view illustrating internal components of a wearable electronic device according to an embodiment.

Referring to FIG. 2, a wearable electronic device 200 according to an embodiment may include at least one of a light output module 211, a display member 201, and a camera module 250.

According to an embodiment, the light output module 211 may include a light source capable of outputting an image, and a lens that guides the image to the display member 201. According to an embodiment, the light output module 211 may include at least one of a liquid crystal display (LCD), a digital mirror device (DMD), a liquid crystal on silicon (LCoS), an organic light emitting diode (OLED), or a micro LED.

According to an embodiment, the display member 201 may include an optical waveguide (e.g., a waveguide). According to an embodiment, an output image of the light output module 211 incident on one end of the optical waveguide may be propagated through the optical waveguide and provided to a user. According to an embodiment, the optical waveguide may include at least one of a diffractive element (e.g., a diffractive optical element (DOE) or a holographic optical element (HOE)) or a reflective element (e.g., a reflective mirror). For example, the optical waveguide may guide the output image of the light output module 211 to the user's eye by using at least one diffractive element or reflective element.

According to an embodiment, the camera module 250 may capture a still image and/or a video. According to an embodiment, the camera module 250 may be disposed within a lens frame and disposed around the display member 201.

According to an embodiment, a first camera module 251 may capture and/or recognize the trajectory of the user's eye (e.g., pupil or iris) or gaze. According to an embodiment, the first camera module 251 may periodically or aperiodically transmit information (e.g., trajectory information) related to the trajectory of the user's eye or gaze to a processor (e.g., the processor 120 of FIG. 1).

According to an embodiment, a second camera module 253 may capture an external image.

According to an embodiment, a third camera module 255 may be used for hand detection and tracking, and user gesture (e.g., hand movement) recognition. The third camera module 255 according to an embodiment may be used for 3 degrees of freedom (3DoF) or 6DoF head tracking, location (space or environment) recognition, and/or movement recognition. The second camera module 253 may also be used for hand detection and tracking, and user gesture recognition according to an embodiment. According to an embodiment, at least one of the first camera module 251 to the third camera module 255 may be replaced with a sensor module (e.g., a LiDAR sensor). For example, the sensor module may include at least one of a vertical cavity surface emitting laser (VCSEL), an IR sensor, and/or a photodiode.

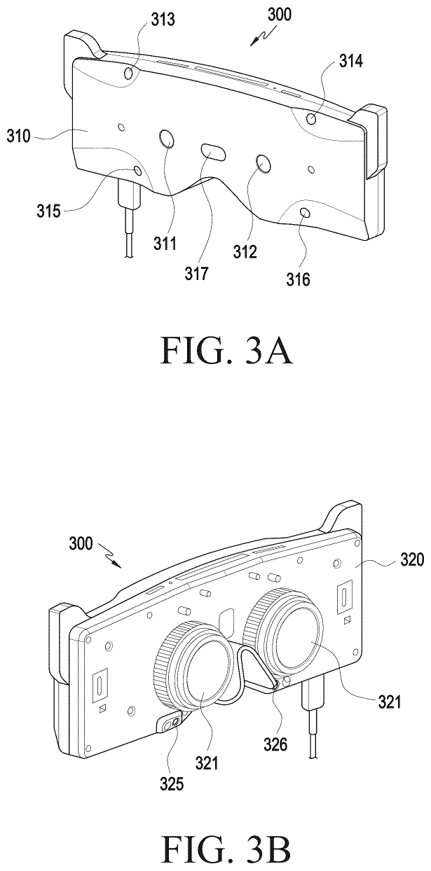

FIG. 3A is a front view illustrating a wearable electronic device according to an embodiment.

FIG. 3B is a rear view illustrating a wearable electronic device according to an embodiment.

Referring to FIGS. 3A and 3B, in an embodiment, camera modules 311, 312, 313, 314, 315, and 316 and/or a depth sensor 317 may be disposed on a first surface 310 of a housing to obtain information related to a surrounding environment of the wearable electronic device 300.

In an embodiment, the camera modules 311 and 312 may obtain an image related to the surrounding environment of the wearable electronic device.

In an embodiment, the camera modules 313, 314, 315, and 316 may obtain an image, while the wearable electronic device is worn by the user. The camera modules 313, 314, 315, and 316 may be used for hand detection and tracking, and user gesture (e.g., hand movement) recognition. The camera modules 313, 314, 315, and 316 may be used for 3DoF or 6DoF head tracking, location (space or environment) recognition, and/or movement recognition. In an embodiment, the camera modules 311 and 312 may also be used for hand detection and tracking, and user gesture recognition.

In an embodiment, the depth sensor 317 may be configured to transmit a signal and receive a signal reflected from an object, and used for the purpose of identifying a distance to an object, such as time of flight (TOF). Alternatively or additionally to the depth sensor 217, the camera modules 313, 314, 315, and 316 may identify a distance to an object.

According to an embodiment, face recognition camera modules 325 and 326 and/or a display 321 (and/or a lens) may be disposed on a second surface 320 of the housing.

In an embodiment, the face recognition camera modules 325 and 326 adjacent to the display may be used for the purpose of recognizing the user's face or may recognize and/or track both eyes of the user.

In an embodiment, the display 321 (and/or the lens) may be disposed on the second surface 320 of the wearable electronic device 300. In an embodiment, the wearable electronic device 300 may not include the camera modules 315 and 316 among a plurality of camera modules 313, 314, 315, and 316. Although not shown in FIGS. 3A and 3B, the wearable electronic device 300 may further include at least one of the components illustrated in FIG. 2.

As described above, according to an embodiment, the wearable electronic device 300 may have a form factor for being worn on the user's head. The wearable electronic device 300 may further include a strap and/or wearing member to be secured on a body part of the user. The wearable electronic device 300 may provide a user experience based on augmented reality, virtual reality, and/or mixed reality, while worn on the user's head.

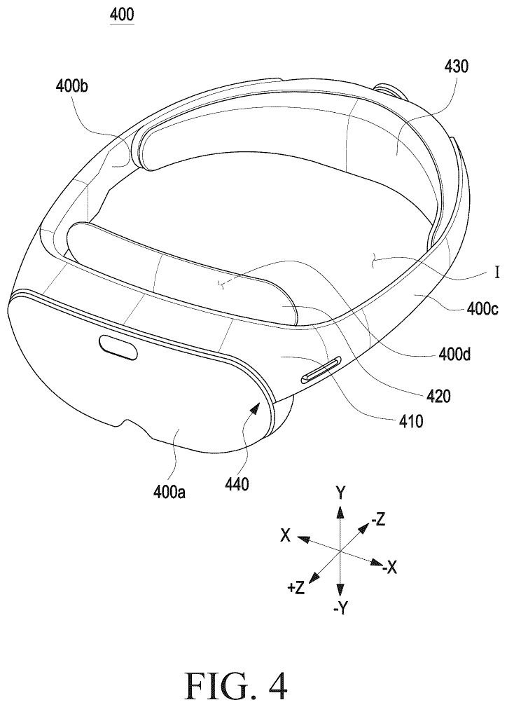

FIG. 4 is another perspective view illustrating an electronic device according to an embodiment.

Referring to FIG. 4, an electronic device 400 may be a head-mounted device (HMD) capable of providing an image in front of a user's eyes. The configuration of the electronic device 400 in FIG. 4 may be wholly or partially the same as the configuration of the electronic device 200 in FIG. 2.

According to an embodiment, the electronic device 400 may include housings 410, 420, and 430 that may form the exterior of the electronic device 400 and provide a space for arranging components of the electronic device 400 therein.

According to an embodiment, the electronic device 400 may include a first housing 410 that may surround at least a portion of the user's head. According to an embodiment, the first housing 410 may include a first surface 400a facing the outside of the electronic device 400 (e.g., in a +Z direction).

According to an embodiment, the first housing 410 may surround at least a portion of an internal space I. For example, the first housing 410 may include a second surface 400b facing the internal space I of the electronic device 400 and a third surface 400c opposite to the second surface 400b. According to an embodiment, the first housing 410 may be combined with the third housing 430 to form a closed-curve shape surrounding the internal space I.

According to an embodiment, the first housing 410 may accommodate at least some of the components of the electronic device 400. For example, an optical output module and a circuit board may be disposed within the first housing 410.

According to an embodiment, the electronic device 400 may include a single display member 440 corresponding to the user's left and right eyes. The display member 440 may be disposed in the first housing 410. The configuration of the display member 440 in FIG. 4 may be wholly or partially the same as the configuration of the display member 201 in FIG. 2.

According to an embodiment, the electronic device 400 may include a second housing 420 that may be seated on the user's face. According to an embodiment, the second housing 420 may include a fourth surface 400d that may at least partially face the user's face. According to an embodiment, the fourth surface 400d may be a surface in a direction (e.g., a −Z direction) facing the internal space I of the electronic device 400. According to an embodiment, the second housing 420 may be combined with the first housing 410.

According to an embodiment, the electronic device 400 may include a third housing 430 that may be seated on the back of the user's head. According to an embodiment, the third housing 430 may be combined with the first housing 410. According to an embodiment, the third housing 430 may accommodate at least some of the components of the electronic device 400. For example, a battery (e.g., the battery 189 of FIG. 1) may be disposed within the third housing 430.

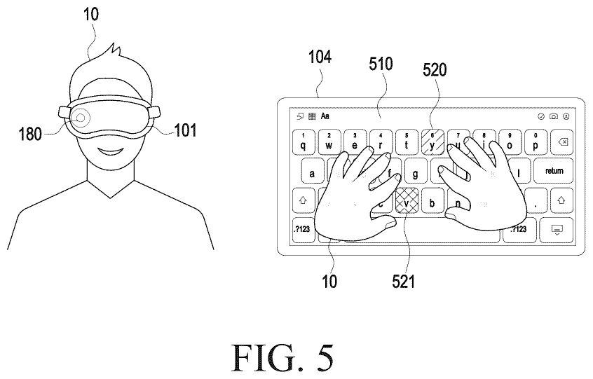

FIG. 5 is a diagram illustrating an operation of identifying a user input from an external electronic device by an electronic device according to an embodiment.

Referring to FIG. 5, the electronic device 101 (e.g., the electronic device 101 of FIG. 1, the processor 120 of FIG. 1, the wearable electronic device 200 of FIG. 2, the wearable electronic device 300 of FIG. 3A, the wearable electronic device 300 of FIG. 3B, or the electronic device 400 of FIG. 4) may be a wearable electronic device (e.g., an HMD device or smart glasses) mounted or positioned upon on the body of a user 10.

According to an embodiment, the electronic device 101 may obtain a user input from the user 10 through a keyboard 510 displayed on the external electronic device 104 (e.g., the electronic device 104 of FIG. 1) through the camera 180 (e.g., the camera module 180 of FIG. 1). According to an embodiment, the external electronic device 104 may be in a communication disconnection state with the electronic device 101, such that the electronic device 101 and the external electronic device 104 are not directly exchanging signals/data while the user input is obtained.

According to an embodiment, upon receipt of a user input (e.g., a ten-finger touch) for displaying the keyboard 510, the external electronic device 104 may display the keyboard 510.

According to an embodiment, the external electronic device 104 may display color indicators 520 and 521 corresponding to keys selected by the user 10 among a plurality of keys included in the keyboard 510.

According to an embodiment, the electronic device 101 may capture the color indicators 520 and 521 displayed on the external electronic device 104 through the camera 180, and identify the keys selected by the user 10 based on color information of the color indicators.

According to an embodiment, when the electronic device 101 displays a virtual reality (VR) screen, which is an image of a virtual space rather than an image of a real space obtained through (or captured by) the camera 180, the electronic device 101 may obtain an image corresponding to the external electronic device 104 included in an image obtained through the camera 180, and display the image corresponding to the external electronic device 104 on the VR screen. For example, the electronic device 101 may crop the image corresponding to the external electronic device 104 included in the image of the real space obtained through the camera 180, and display the cropped image on the VR screen. As a result, the electronic device 101 may replace only an area mapped to the boundary of the external electronic device 104 with the image of the real space, thereby converting an area of the external electronic device 104 into a see-through screen.

According to an embodiment, the electronic device 101 may use the external electronic device 104 as a keyboard without scanning and pairing for a communication connection to the external electronic device 104. For example, difficulties associated with accessing and configuring a communication connection screen, a password input screen, and/or a keyboard use settings screen on the electronic device 101, along with power control of the external electronic device 104 when used as a keyboard in an XR environment, may be reduced. Further, the electronic device 101 may use the external electronic device 104 as a keyboard without displaying a virtual keyboard for password input and receiving a user input through the virtual keyboard on the password input screen.

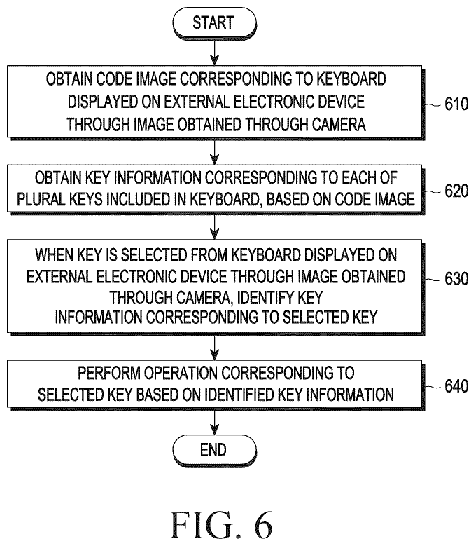

The operation of using an external electronic device as a keyboard will be described in more detail with reference to FIGS. 6 to 13.

FIG. 6 is a flowchart illustrating an operation of identifying a user input from an external electronic device by an electronic device according to an embodiment. The operation described in FIG. 6 may be performed by the electronic device. The memory of the electronic device may store instructions that cause the electronic device to perform the following operations.

Referring to FIG. 6, in operation 610, the electronic device (e.g., the electronic device 101 of FIG. 1, the processor 120 of FIG. 1, the wearable electronic device 200 of FIG. 2, the wearable electronic device 300 of FIG. 3A, the wearable electronic device 300 of FIG. 3B, or the electronic device 400 of FIG. 4) may obtain a code image corresponding to a keyboard displayed on the external electronic device (e.g., the electronic device 104 of FIG. 1) through an image obtained through a camera (e.g., the camera module 180 of FIG. 1). According to an embodiment, the code image may include at least one of a quick response (QR) code or a barcode.

According to an embodiment, the electronic device may further include a communication module (e.g., the communication module 190 of FIG. 1). The communication module may include various communication circuitry. According to an embodiment, the communication module may be in a communication disconnection state with the external electronic device.

According to an embodiment, the electronic device may display an augmented reality (AR) screen on a display (e.g., the display module 160 of FIG. 1). According to an embodiment, displaying the AR screen may involve displaying an image of a real space obtained through the camera on the display. According to an embodiment, the AR screen may further display a virtual object along with the image of the real space.

According to an embodiment, while displaying the AR screen, the electronic device may display the external electronic device included in the image of the real space on the display. For example, the external electronic device may display a keyboard and a code image corresponding to the keyboard based on reception of a user input for keyboard display. According to an embodiment, the electronic device may display the external electronic device with the keyboard and the corresponding code image on the display, and obtain the code image displayed on the external electronic device.

According to an embodiment, the electronic device may display a VR screen on the display. According to an embodiment, displaying the VR screen may involve displaying an image of a virtual space, rather than an image of a real space obtained through the camera, on the display.

According to an embodiment, while displaying the VR screen, the electronic device may obtain an image corresponding to the external electronic device included in the image obtained through the camera, and display the image corresponding to the external electronic device on the VR screen. For example, the electronic device may crop the image corresponding to the external electronic device included in the image of the real space obtained through the camera, and display the cropped image on the VR screen.

According to an embodiment, the electronic device may display the cropped image on the VR screen based on the position of the external electronic device included in the image of the real space.

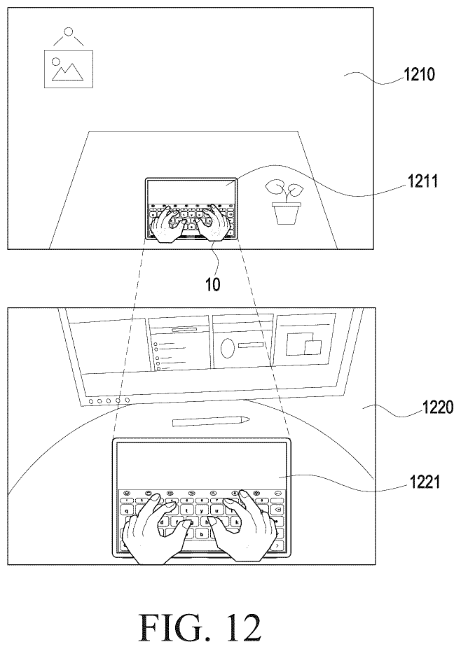

According to an embodiment, the electronic device may also magnify the cropped image and display it on the VR screen. According to an embodiment, the operation of magnifying the cropped image and displaying it on the VR screen will be described below in more detail with reference to FIG. 12.

According to an embodiment, the external electronic device may display a keyboard and a code image corresponding to the keyboard based on reception of a user input for keyboard display. According to an embodiment, the electronic device may display the external electronic device with the keyboard and the corresponding code image on the display, and obtain the code image displayed on the external electronic device.

As described above, the electronic device may replace only an area mapped to the boundary of the external electronic device with the image of the real space, thereby converting an area of the external electronic device into a see-through screen.

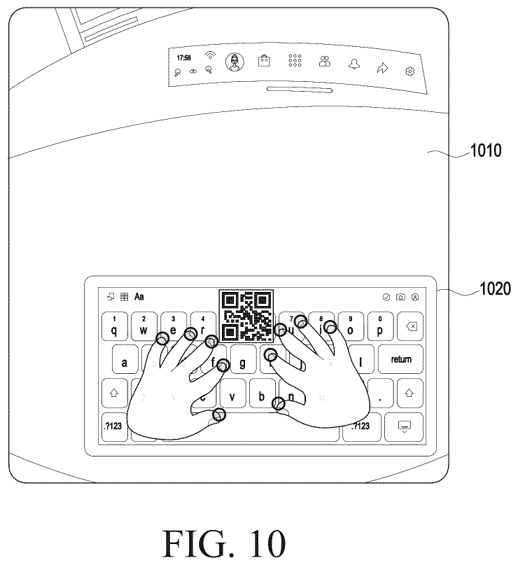

According to an embodiment, the operation of replacing and displaying an area where the external electronic device is located with an image of a real space, while displaying a VR screen will be described below in more detail with reference to FIG. 10.

According to an embodiment, the external electronic device may be a foldable device. According to an embodiment, the electronic device may detect unfolding of the external electronic device, which is a foldable device, through the camera. According to an embodiment, the unfolding may include unfolding the external electronic device in a folded state.

According to an embodiment, the external electronic device may be a rollable device. According to an embodiment, the electronic device may detect opening (or unfolding) of the display of the external electronic device, which is a rollable device, through the camera. According to an embodiment, the opening (or unfolding) may include unrolling the display of the external electronic device in a rolled state (or folded state).

According to an embodiment, based on detecting the unfolding of the external electronic device, the electronic device may obtain an image corresponding to the external electronic device included in the image obtained through the camera, and display the image corresponding to the external electronic device on the VR screen.

According to an embodiment, in the case where the external electronic device is in a bar form that is not foldable, when the keyboard and the code image corresponding to the keyboard are displayed on the external electronic device, the electronic device may obtain the image corresponding to the external electronic device included in the image obtained through the camera, and display the image corresponding to the external electronic device on the VR screen.

According to an embodiment, in operation 620, the electronic device may obtain key information corresponding to each of a plurality of keys included in the keyboard, based on the code image.

According to an embodiment, the electronic device may obtain information (or key information) about the plurality of keys included in the keyboard included in the code image by analyzing the code image. For example, the electronic device may obtain information (e.g., a key code value) about each of the plurality of keys included in the keyboard, color information corresponding to each of the plurality of keys, information about positions where the color information corresponding to the plurality of keys is displayed, and/or position information about the plurality of keys on the keyboard, which are included in the code image. According to an embodiment, the electronic device may store, in memory (e.g., the memory 130 of FIG. 1), the information about each of the plurality of keys included in the keyboard, the color information corresponding to each of the plurality of keys, the information about positions where the color information corresponding to the plurality of keys is displayed, and/or the position information about the plurality of keys on the keyboard, which are based on the code image, by mapping the information for each key.

In the disclosure, it has been described that the code image includes the color information for identifying the plurality of keys, to which the disclosure is not limited. For example, the code image may include pattern information, text information, or image information corresponding to the plurality of keys, instead of or in addition to the color information for identifying the plurality of keys.

According to an embodiment, in operation 630, when a key is selected from the keyboard displayed on the external electronic device through the image obtained through the camera, the electronic device may identify key information corresponding to the selected key.

According to an embodiment, the electronic device may identify the color of a color indicator displayed on the external electronic device through the image obtained through the camera. According to an embodiment, the color indicator may correspond to the key selected from the keyboard displayed on the external electronic device. According to an embodiment, the color indicator may be changed to a color corresponding to the selected key in response to the order of selected keys through the external electronic device. According to an embodiment, the color indicator may be displayed at the position of the selected key, or at a position unrelated to the selected key. According to an embodiment, each time the color indicator is displayed, it may be displayed at the same position, or at a different position.

According to an embodiment, the arrangement of the plurality of keys included in the keyboard may be changed in response to a key selection operation. For example, the arrangement of the plurality of keys included in the keyboard may be changed in response to the key selection operation being received a set number of times (e.g., one or more times). According to an embodiment, at least one of an array in which the plurality of keys may be arranged or positions where the plurality of keys are arranged may be changed. In this way, even if the arrangement of keys included in the keyboard changes, since the colors corresponding to the keys are the same, the electronic device may identify the color of the color indicator corresponding to the selected key displayed on the external electronic device.

According to an embodiment, the electronic device may identify the selected key information based on the plurality pieces of color information included in the key information and the color of the color indicator. For example, the electronic device may identify color information corresponding to the color of the color indicator among the plurality of pieces of color information included in the key information. According to an embodiment, the electronic device may identify a key code value corresponding to the identified color information.

According to an embodiment, the electronic device may identify the colors and order of color indicators. According to an embodiment, based on the color information stored in the memory, the electronic device may identify keys corresponding to the colors of the color indicators, in the order of the colors of the color indicators. For example, when a ‘y’ key and a ‘v’ key are sequentially selected among the plurality of keys, the external electronic device may sequentially display an indicator (e.g., yellow) corresponding to the ‘y’ key and an indicator (e.g., blue/violet) corresponding to the ‘v’ key. According to an embodiment, the electronic device may identify the colors of the indicators in the order of yellow and blue/violet, and based on the order of the colors, identify that the ‘v’ key was selected after the ‘y’ key.

According to an embodiment, the electronic device may further obtain the position information about the plurality of keys included in the keyboard based on the code image, and identify the selected key by further considering the position of the color indicator.

According to an embodiment, based on the code image, the electronic device may identify selection of two or more of the plurality of keys, and identify the selection of the two or more of the plurality of keys based on the colors and/or positions of color indicators.

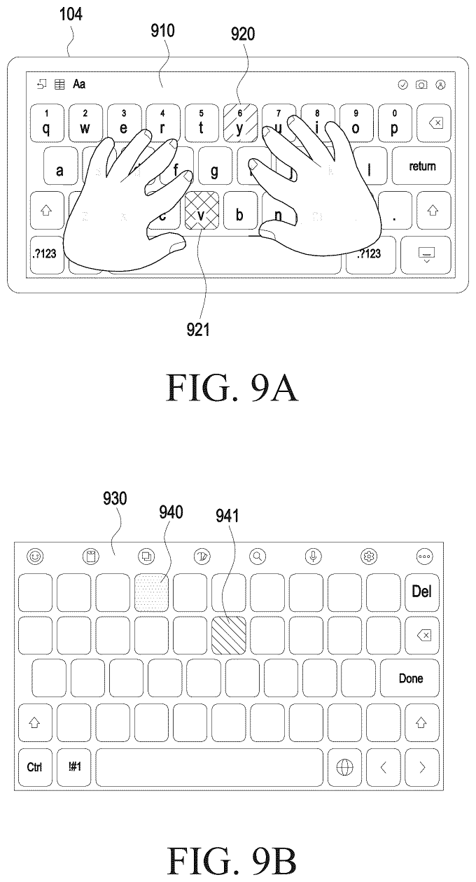

According to an embodiment, the operation of identifying a selected key based on a color indicator will be described below in more detail with reference to FIGS. 9A and 9B.

According to an embodiment, the electronic device may identify the selected key based on the color of the color indicator displayed at a position unrelated to the position of the selected key on the external electronic device. For example, the color indicator may be displayed at the same position regardless of the position of the selected key on the external electronic device. For example, the position of the color indicator on the external electronic device may change randomly each time.

According to an embodiment, the electronic device may identify the position of a highlight displayed on the external electronic device through the image obtained through the camera. According to an embodiment, the highlight may be displayed at the position of the key selected from the keyboard displayed on the external electronic device. For example, the highlight may be displayed on at least a portion of the border of the selected key, or on at least a portion of a key area.

According to an embodiment, the electronic device may identify a key code value corresponding to the identified position of the highlight.

According to an embodiment, when the code image includes pattern information, text information, or image information corresponding to the plurality of keys, instead of or in addition to the color information for identifying the plurality of keys, the electronic device may identify the pattern information, text information, or image information displayed on the external electronic device through the image obtained through the camera. According to an embodiment, the electronic device may identify a key code value corresponding to the identified pattern information, text information, or image information.

According to an embodiment, in operation 640, the electronic device may perform an operation corresponding to the selected key based on the identified key information.

According to an embodiment, the electronic device may perform an operation corresponding to the key code value identified based on the color information and/or position information about the color indicator. For example, the electronic device may display text corresponding to the identified key code value on the display. According to an embodiment, the electronic device may perform a function corresponding to an identified key code value such as copy, paste, shift, delete, and backspace.

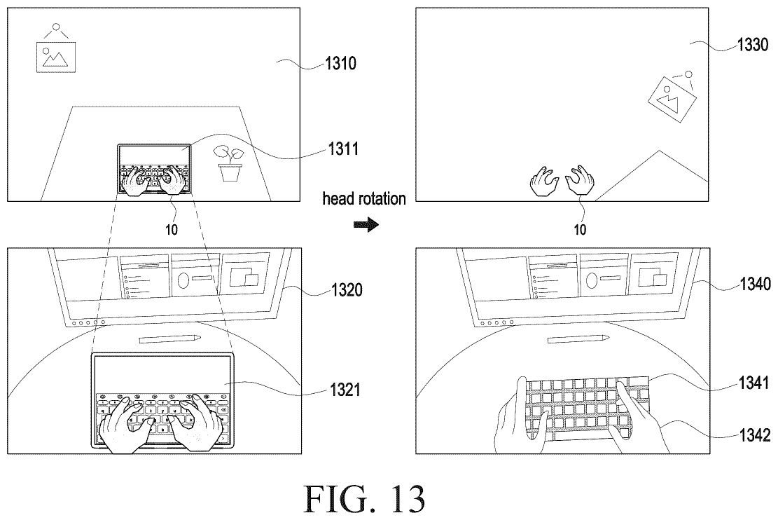

According to an embodiment, when the external electronic device is not included in the image obtained through the camera due to rotation of the electronic device after the electronic device obtains information through the code image, the electronic device may display a virtual keyboard on the display. According to an embodiment, an embodiment of displaying a virtual keyboard when the external electronic device is not captured due to the rotation of the electronic device will be described below in more detail with reference to FIG. 13.

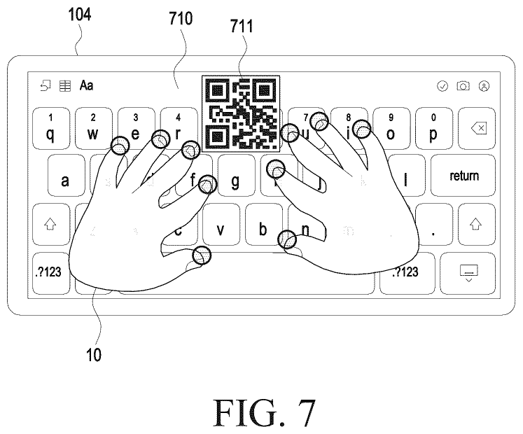

FIG. 7 is a diagram illustrating a keyboard screen displayed on an external electronic device according to an embodiment.

Referring to FIG. 7, when receiving a user input for keyboard display, the external electronic device 104 (e.g., the electronic device 104 of FIG. 1) may display a keyboard 710. For example, when receiving a user input, such as a ten-finger touch, the external electronic device 104 may display the keyboard 710. For example, when receiving an input (e.g., gesture or voice recognition) for executing the keyboard 710, the external electronic device 104 may display the keyboard 710.

According to an embodiment, the external electronic device 104 may further display a code image 711 corresponding to the keyboard 710, along with the keyboard 710. For example, the code image 711 may include at least one of a QR code or barcode containing information related to the keyboard 710. According to an embodiment, the code image 711 may include at least one of information about a plurality of keys included in the keyboard 710, color information corresponding to each of the plurality of keys, information about positions where the color information corresponding to the plurality of keys is displayed, or position information about the plurality of keys.

According to an embodiment, the electronic device (e.g., the electronic device 101 of FIG. 1) may capture the code image 711 through a camera (e.g., the camera module 180 of FIG. 1) included in the electronic device, and analyze the captured code image 711 to obtain information about the keyboard 710 displayed on the external electronic device 104.

According to an embodiment, the electronic device may store information for code image analysis in memory (e.g., the memory 130 of FIG. 1), and obtain information about the keyboard 710 displayed on the external electronic device 104 based on the code image 711 obtained through the camera and the information for code image analysis stored in the memory.

According to an embodiment, the electronic device may transmit the code image 711 obtained through the camera to a server (e.g., the server 108 of FIG. 1), and obtain information about the keyboard 710 displayed on the external electronic device 104 from the server.

According to an embodiment, when at least one of the plurality of keys included in the keyboard 710 is selected by the user 10, the external electronic device 104 may display a color indicator of a color corresponding to the at least one selected key. According to an embodiment, when a plurality of keys are sequentially selected, the external electronic device 104 may display color indicators of colors corresponding to the plurality of keys in response to the order of the plurality of keys. According to an embodiment, when the plurality of keys are simultaneously selected, the external electronic device 104 may simultaneously display a plurality of color indicators including colors corresponding to the plurality of keys, respectively in different areas.

According to an embodiment, the electronic device may obtain color information about the color indicator through the camera and compare it with stored color information to identify the selected key.

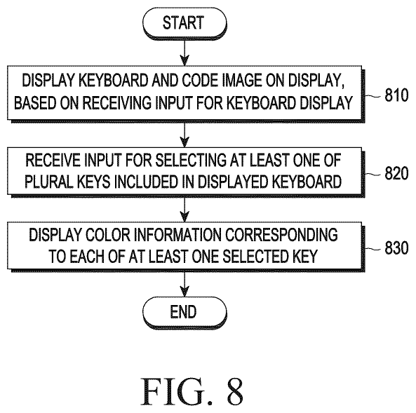

FIG. 8 is a diagram illustrating a user input operation through a keyboard screen displayed on an external electronic device according to an embodiment.

Referring to FIG. 8, in operation 810, the external electronic device (e.g., the electronic device 104 of FIG. 1) may display a keyboard and a code image on its display, based on reception of an input for keyboard display. For example, when receiving an input for keyboard display, such as a ten-finger touch, a voice command for keyboard display, or selection of an icon for keyboard display, the external electronic device may display the keyboard and the code image corresponding to the keyboard on the display. According to an embodiment, the external electronic device may display information about each key on the key included in the keyboard, or may display only the arrangement of keys without information about the keys.

According to an embodiment, in the case where the external electronic device is a foldable device, when detecting unfolding of a display and/or receiving an input for keyboard display, it may display a keyboard and a code image corresponding to the keyboard on its display.

According to an embodiment, in the case where the external electronic device is a rollable device, when detecting unrolling of the display and/or receiving an input for keyboard display, it may display a keyboard and a code image corresponding to the keyboard on its display.

According to an embodiment, in the case where the external electronic device is a foldable device or a rollable device, when detecting unfolding of a display and receiving an input for keyboard display (e.g., a ten-finger touch input, a gesture input, or a voice input) within a specified time, it may display a keyboard and a code image corresponding to the keyboard on the display.

According to an embodiment, the code image may include at least one of a QR code or barcode containing information related to the keyboard. According to an embodiment, the code image may include at least one of information about a plurality of keys included in the keyboard, color information corresponding to each of the plurality of keys, information about positions where the color information corresponding to the plurality of keys is displayed, or position information about the plurality of keys.

According to an embodiment, in operation 820, the external electronic device may receive an input for selecting at least one of the plurality of keys included in the displayed keyboard. For example, the external electronic device may receive an input for selecting at least one of the plurality of keys included in the keyboard by a user touch. According to an embodiment, in addition to the user touch, the external electronic device may receive an input for selecting at least one of the plurality of keys included in the keyboard through an input device connected to the external electronic device, such as a stylus pen or a mouse.

According to an embodiment, in operation 830, the external electronic device may display color information corresponding to each of the at least one selected key.

According to an embodiment, when at least one of the plurality of keys included in the keyboard is selected, the external electronic device may display a color indicator of a color corresponding to the at least one selected key. According to an embodiment, when a plurality of keys are sequentially selected, the external electronic device may display color indicators of colors corresponding to the plurality of keys in response to the order of the plurality of keys. According to an embodiment, when the plurality of keys are simultaneously selected, the external electronic device may display a color indicator corresponding to the selected plurality of keys or simultaneously display a plurality of color indicators including colors corresponding to the selected plurality of keys, respectively in different areas.

According to an embodiment, the external electronic device may display the color indicator at the position of the selected key. According to an embodiment, the external electronic device may also display the color indicator at a position unrelated to the position of the selected key. For example, the color indicator may be displayed in a specific area on the external electronic device, regardless of the position of the selected key on the external electronic device. For example, the position where the color indicator is displayed on the external electronic device may change randomly each time it is displayed on the external electronic device.

FIG. 9A is a diagram illustrating an operation of displaying a color indicator based on a user input on a keyboard screen displayed on an external electronic device according to an embodiment.

Referring to FIG. 9A, when receiving a user input for keyboard display, the external electronic device 104 (e.g., the electronic device 104 of FIG. 1) may display a keyboard 910 and a code image corresponding to the keyboard 910. For example, the code image may include at least one of a QR code or barcode containing information related to the keyboard 910. According to an embodiment, the code image may include at least one of information about a plurality of keys included in the keyboard 910, color information corresponding to each of the plurality of keys, information about positions where the color information corresponding to the plurality of keys is displayed, or position information about the plurality of keys.

According to an embodiment, after displaying the keyboard 910 and the code image, the external electronic device 104 may display only the keyboard 910 and delete the code image, when a set time has elapsed.

According to an embodiment, when the external electronic device 104 receives a user input for selecting at least one of a plurality of keys included in the keyboard 910, it may display color indicators 920 and 921 corresponding to the selected keys. For example, when receiving a user input selecting the ‘y’ key and the ‘v’ key among the plurality of keys, the external electronic device 104 may display an indicator 920 of a color (e.g., yellow) corresponding to the ‘y’ key and an indicator 921 of a color (e.g., blue/violet) corresponding to the ‘v’ key.

According to an embodiment, when the ‘y’ key and the ‘v’ key are sequentially selected among the plurality of keys, the external electronic device 104 may sequentially display the indicator 920 of the color (e.g., yellow) corresponding to the ‘y’ key and the indicator 921 of the color (e.g., blue/violet) corresponding to the ‘v’.

According to an embodiment, when the ‘y’ key and the ‘v’ key are simultaneously selected among the plurality of keys, the external electronic device 104 may simultaneously display the indicator 920 of the color (e.g., yellow) corresponding to the ‘y’ key and the indicator 921 of the color (e.g., blue/violet) corresponding to the ‘v’.

According to an embodiment, the external electronic device 104 may display the color indicator 920 corresponding to ‘y’ at the position of the selected ‘y’ key, and the color indicator 921 corresponding to ‘v’ at the position of the selected ‘v’ key.

According to an embodiment, the external electronic device 104 may also display the color indicators 920 and 921 at positions unrelated to the positions of the selected ‘y’ key and ‘v’ key. For example, the external electronic device 104 may display the color indicators 920 and 921 in a specific area within the keyboard 910. For example, the external electronic device 104 may display the color indicators 920 and 921 in different areas (e.g., at random positions) within the keyboard 910, each time they are displayed.

As described above, since the external electronic device displays the color indicator corresponding to the selected key, the electronic device may recognize the color of the color indicator through the camera and identify the keyboard input, even if it is not communication-connected to the external electronic device.

Further, when the color indicator is displayed at a position unrelated to the selected key, it becomes difficult to visually identify the selected key, which may enhance security when entering personal information or a password.

Further, when the color indicator is displayed at a position unrelated to the selected key, it may reduce the problem of the color indicator being obscured by the user's finger.

According to an embodiment, although FIG. 9A illustrates displaying the keyboard 910 that includes key layout information, the external electronic device may also display a keyboard that does not include key layout information as illustrated in FIG. 9B.

According to an embodiment, the external electronic device may display the color indicator for a set time. For example, when the display time for the color indicator is set short, the external electronic device may terminate the display of the color indicator before receiving a next input for selecting a key.

According to an embodiment, when the display time for the color indicator is set long, the external electronic device may maintain the display of the color indicator corresponding to the previously selected key even after receiving the next input for selecting a key, or it may display different colors in relation to an order in which keys were selected.

According to an embodiment, when a plurality of color indicators are displayed, a color indicator corresponding to a later-selected key may be in a color indicating that it was selected after a key corresponding to another color indicator displayed concurrently. For example, when only the ‘y’ key is selected, a ‘light yellow’ color indicator is displayed, and when two color indicators are displayed together as the ‘y’ key is selected after another key, a ‘dark yellow’ color indicator indicating that ‘y’ was the subsequently selected key may be displayed. According to an embodiment, information about colors displayed differently in relation to an order in which keys are selected may be included in the code image.

As described above, when the display time for the color indicator is set long, the selected key may be identified through color recognition, even if an image processing speed of the electronic device is low.

FIG. 9B is a diagram illustrating an operation of displaying a color indicator based on a user input on a keyboard screen displayed on an external electronic device according to an embodiment.

Referring to FIG. 9B, the external electronic device (e.g., the electronic device 104 of FIG. 1) may display a keyboard 930 that does not include key layout information. According to an embodiment, the external electronic device may display the keyboard 930 that includes only the arrangement of keys without key layout information. According to an embodiment, even if the external electronic device does not display key layout information, the electronic device may provide the key layout information based on key arrangement information obtained through a code image displayed on the external electronic device.

According to an embodiment, the external electronic device may display color indicators 940 and 941 corresponding to at least one selected keys among a plurality of keys included in the keyboard 930.

According to an embodiment, the external electronic device may display the color indicators 940 and 941 corresponding to the selected keys at the positions of the one or more selected keys.

According to an embodiment, the external electronic device may also display the color indicators 940 and 941 at positions unrelated to the positions of the selected keys. For example, the external electronic device may display the color indicators 940 and 941 in a specific area within the keyboard 930, or may display them in different areas (e.g., at random positions) within the keyboard 930, each time they are displayed.

As described above, since the external electronic device displays the color indicators corresponding to the selected keys, the electronic device may recognize the colors of the color indicators through the camera and identify a keyboard input, even if it is not communication-connected to the external electronic device.

Further, when the color indicators are displayed at the positions unrelated to the selected keys, it becomes difficult to visually identify the selected keys, which may enhance security when entering personal information or a password.

Further, not displaying key layout information may enhance security when entering personal information or a password.

FIG. 10 is a diagram illustrating a keyboard screen of an external electronic device displayed on a VR screen of an electronic device according to an embodiment.

Referring to FIG. 10, the electronic device (e.g., the electronic device 101 of FIG. 1, the processor 120 of FIG. 1, the wearable electronic device 200 of FIG. 2, the wearable electronic device 300 of FIG. 3A, the wearable electronic device 300 of FIG. 3B, or the electronic device 400 of FIG. 4) may display a VR screen 1010 on a display (e.g., the display module 160 of FIG. 1). According to an embodiment, displaying the VR screen 1010 may involve displaying an image of a virtual space, rather than an image of a real space obtained through a camera (e.g., the camera module 180 of FIG. 1), on the display.

According to an embodiment, while displaying the VR screen, the electronic device may obtain an image 1020 corresponding to the external electronic device included in the image obtained through the camera, and display the image 1020 corresponding to the external electronic device on the VR screen 1010. For example, the electronic device may crop the image 1020 corresponding to the external electronic device included in the image of the real space obtained through the camera, and display the cropped image 1020 on the VR screen 1010.

According to an embodiment, when the electronic device recognizes that a keyboard screen or a code image is included in the image obtained through the camera, it may crop the image 1020 corresponding to the external electronic device included in the image of the real space obtained through the camera, and display the cropped image 1020 on the VR screen 1010.

According to an embodiment, the electronic device may display the cropped image 1020 on the VR screen 1010 based on the position of the external electronic device included in the image of the real space.

According to an embodiment, the electronic device may also magnify the cropped image and display it on the VR screen. According to an embodiment, the operation of magnifying the cropped image and displaying it on the VR screen will be described below in more detail with reference to FIG. 12.

According to an embodiment, the electronic device may display the external electronic device with the keyboard and the code image corresponding to the keyboard on the display, and obtain the code image displayed on the external electronic device.

As described above, the electronic device may replace only an area mapped to the boundary of the external electronic device with the image of the real space, thereby converting an area of the external electronic device into a see-through screen.

According to an embodiment, the external electronic device may be a foldable device. According to an embodiment, the electronic device may detect unfolding of the external electronic device, which is a foldable device, through the camera. According to an embodiment, the unfolding may include unfolding the external electronic device in a folded state.

According to an embodiment, the external electronic device may be a rollable device. According to an embodiment, the electronic device may detect opening (or unfolding) of the external electronic device, which is a rollable device, through the camera. According to an embodiment, the opening may include unrolling the display of the external electronic device in a rolled state.

According to an embodiment, based on detecting the unfolding or unrolling of the external electronic device, the electronic device may obtain an image corresponding to the external electronic device included in the image obtained through the camera, and display the image corresponding to the external electronic device on the VR screen. For example, when the electronic device detects the unfolding of the external electronic device, it may display an image of the external electronic device only as a black screen on the VR screen. According to an embodiment, when a keyboard and a code image corresponding to the keyboard are displayed on the unfolded external electronic device as an input for entering text on the keyboard is received, the electronic device may display an image of the external electronic device with the keyboard and the code image on the VR screen.

According to an embodiment, the electronic device may capture the code image displayed on the external electronic device, and analyze the captured code image to obtain information (e.g., key information, color information corresponding to keys, and/or position information about the keys) about the keyboard displayed on the external electronic device.

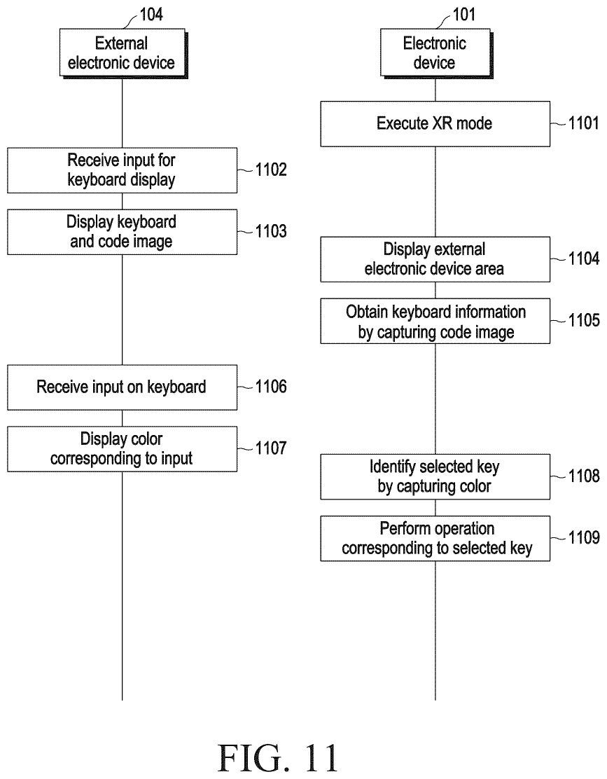

FIG. 11 is a flowchart illustrating an operation of identifying a user input by an electronic device and an external electronic device according to an embodiment. For example, the electronic device 101 may be in a communication disconnection state with the external electronic device 104.

Referring to FIG. 11, in operation 1101, the electronic device 101 (e.g., the electronic device 101 of FIG. 1, the processor 120 of FIG. 1, the wearable electronic device 200 of FIG. 2, the wearable electronic device 300 of FIG. 3A, the wearable electronic device 300 of FIG. 3B, or the electronic device 400 of FIG. 4) may execute an XR mode. For example, when the electronic device 101 detects that the user has worn the electronic device 101, it may execute the XR mode.

According to an embodiment, in operation 1102, the external electronic device 104 (e.g., the external electronic device 104 of FIG. 1) may receive an input for keyboard display. For example, the external electronic device 104 may receive an input such as touching its display with ten fingers, receiving a voice command, or selecting an icon for keyboard display.

According to an embodiment, in operation 1103, the external electronic device 104 may display a keyboard and a code image. For example, the code image may include information about a plurality of keys included in the keyboard, color information corresponding to each of the plurality of keys, position information indicating positions where the color information corresponding to the plurality of keys is displayed, and/or position information corresponding to each of the plurality of keys.

According to an embodiment, in operation 1104, the electronic device 101 may display an area of the external electronic device. For example, when the electronic device 101 displays an AR screen that shows an image of a real space obtained through the camera, it may display the external electronic device included in the image of the real space. According to an embodiment, when the electronic device 101 displays a VR screen that shows an image of a virtual space rather than a real space, it may crop the image of the external electronic device from the image of the real space obtained through the camera, and display the cropped image of the external electronic device on the VR screen.

According to an embodiment, in operation 1105, the electronic device 101 may obtain keyboard information by capturing the code image displayed on the external electronic device 104. For example, the electronic device 101 may capture the code image displayed on the external electronic device 104 through the camera, and analyze the captured code image to obtain information (e.g., the information about the plurality of keys included in the keyboard, the color information corresponding to each of the plurality of keys, and/or the position information corresponding to each of the plurality of keys) about the keyboard included in the code image.

According to an embodiment, in operation 1106, the external electronic device 104 may receive an input on the keyboard. For example, the external electronic device 104 may receive a user touch input for selecting at least one of the plurality of keys included in the keyboard, a touch input of a stylus pen, and/or an input from an input device connected to the external electronic device 104, such as a mouse.

According to an embodiment, in operation 1107, the external electronic device 104 may display a color corresponding to the input. For example, the external electronic device 104 may display a color indicator of a color corresponding to each of the at least one selected key.

According to an embodiment, in operation 1108, the electronic device 101 may identify the selected key by capturing the color. For example, the electronic device 101 may capture a color indicator displayed on the external electronic device 104 through the camera, and identify the color of the color indicator. According to an embodiment, the electronic device 101 may identify key information corresponding to the color of the color indicator using the color information obtained through the code image. According to an embodiment, the electronic device may also identify the key information by further considering the position of the color indicator, in addition to the color of the color indicator.

According to an embodiment, in operation 1109, the electronic device 101 may perform an operation corresponding to the selected key. For example, the electronic device 101 may identify the key selected on the external electronic device 104 based on the identified key information, and perform a text input corresponding to the selected key or a function such as copy, paste, shift, delete, and backspace corresponding to the selected key.

As described above, even if the electronic device and the external electronic device are in a communication disconnection state, the electronic device may identify a keyboard input entered on the external electronic device through color information while in the communication disconnection state.

FIG. 12 is a diagram illustrating a magnified keyboard screen of an external electronic device displayed on a VR screen of an electronic device according to an embodiment.

Referring to FIG. 12, the electronic device (e.g., the electronic device 101 of FIG. 1, the processor 120 of FIG. 1, the wearable electronic device 200 of FIG. 2, the wearable electronic device 300 of FIG. 3A, the wearable electronic device 300 of FIG. 3B, or the electronic device 400 of FIG. 4) may obtain an image 1211 of the external electronic device (e.g., the electronic device 104 of FIG. 1) from an image 1210 of a real space obtained through a camera (e.g., the camera module 180 of FIG. 1). According to an embodiment, the image 1211 of the external electronic device may include a keyboard displayed on the external electronic device, and may further include a hand of the user 10 that performs an input on the keyboard.

According to an embodiment, the electronic device may magnify the obtained image 1211 of the external electronic device, and display the magnified image 1221 on a VR screen 1220 being displayed on a display (e.g., the display module 160 of FIG. 1).

As described above, as the image of the external electronic device including the keyboard is displayed magnified on the VR screen, the user may more easily use the keyboard displayed on the external electronic device.

According to an embodiment, when the electronic device identifies an area of the image 1211 of the external electronic device in the image 1210 of the real space, it may set an area of the image 1211 of the external electronic device as a region of interest (ROI). According to an embodiment, the electronic device may obtain an image by exposing and reading out only the ROI, instead of exposing and reading out an entire area that may be obtained through the camera.

As described above, resource consumption may be reduced by continuously obtaining and/or performing image processing on only an image of a partial area for identifying a keyboard input.

FIG. 13 is a diagram illustrating an operation of displaying a virtual keyboard, when an external electronic device disappears from a screen of an electronic device due to rotation of the electronic device according to an embodiment.

Referring to FIG. 13, the electronic device (e.g., the electronic device 101 of FIG. 1, the processor 120 of FIG. 1, the wearable electronic device 200 of FIG. 2, the wearable electronic device 300 of FIG. 3A, the wearable electronic device 300 of FIG. 3B, or the electronic device 400 of FIG. 4) may obtain an image 1311 of the external electronic device (e.g., the electronic device 104 of FIG. 1) from an image 1310 of a real space obtained through a camera (e.g., the camera module 180 of FIG. 1). According to an embodiment, the image 1311 of the external electronic device may include a keyboard displayed on the external electronic device, and further include a hand of the user 10 performing an input on the keyboard.

According to an embodiment, the electronic device may magnify the obtained image 1311 of the external electronic device, and display the magnified image 1321 on a VR screen 1320 being displayed on a display (e.g., the display module 160 of FIG. 1).

According to an embodiment, when the external electronic device moves out of the field of view of the camera of the electronic device as the user's head wearing the electronic device rotates, the image 1330 of the real space obtained through the camera may include only the hand of the user 10, without including the external electronic device.

According to an embodiment, when the external electronic device is not included in the image 1330 of the real space obtained through the camera, the electronic device may change the VR screen 1320, which was displaying the magnified image 1321 of the external electronic device in a partial area, to a full VR screen 1340.

According to an embodiment, the electronic device may replace the magnified image 1321 of the external electronic device in the real space with a virtual keyboard 1341 and a virtual hand image 1342 corresponding to the hand of the user 10.

As such, even if the external electronic device moves out of the field of view of the camera of the electronic device due to the rotation of the electronic device, a keyboard input may still be performed through the virtual keyboard.

According to an embodiment, a wearable electronic device (e.g., the electronic device 101 of FIG. 1, the wearable electronic device 200 of FIG. 2, the wearable electronic device 300 of FIG. 3A, the wearable electronic device 300 of FIG. 3B, or the electronic device 400 of FIG. 4) may include a camera (e.g., the camera module 180 of FIG. 1), a display (e.g., the display module 160 of FIG. 1), a memory (e.g., the memory 130 of FIG. 1), and at least one processor (e.g., the processor 120 of FIG. 1) including processing circuitry and operatively connected to the camera, the display, and the memory.

According to an embodiment, the memory can store instructions that, when executed by the at least one processor, individually or collectively, cause the wearable electronic device to obtain, from an image captured by the camera, a code image (e.g., the code image 711 of FIG. 7) corresponding to a keyboard (e.g., the keyboard 510 of FIG. 5, the keyboard 710 of FIG. 7, the keyboard 910 of FIG. 9A, or the keyboard 930 of FIG. 9B) displayed on an external electronic device (e.g., the electronic device 104 of FIG. 1 or the external electronic device 104 of FIG. 5).

According to an embodiment, the wearable electronic device can obtain key information corresponding to each of a plurality of keys included in the keyboard, based on the code image.

According to an embodiment, in response to detecting a selection of a key from the keyboard, based on the image captured by the camera, key information corresponding to the selected key can be identified.

According to an embodiment, the wearable electronic device can perform an operation corresponding to the selected key based on the identified key information.

According to an embodiment, the key information may include a plurality of key code values and a plurality of pieces of color information, corresponding to the plurality of keys, respectively.

According to an embodiment, the instructions can cause the wearable electronic device to identify a color of a color indicator (e.g., the color indicators 520 and 521 of FIG. 5, the color indicators 920 and 921 of FIG. 9A, or the color indicators 940 and 941 of FIG. 9B) displayed on the external electronic device, through the image obtained through the camera.

According to an embodiment, the instructions can cause the wearable electronic device to identify color information corresponding to the identified color among the plurality of pieces of color information, identify a key code value corresponding to the identified color information, and perform an operation corresponding to the identified key code value.

According to an embodiment, the color indicator may correspond to the selected key.

According to an embodiment, the instructions can cause the wearable electronic device to obtain an image corresponding to the external electronic device included in the image obtained through the camera, while displaying a VR screen 1010 through the display and display the image (e.g., the image 1020 corresponding to the external electronic device in FIG. 10) corresponding to the external electronic device on the VR screen (e.g., the VR screen 1010 of FIG. 10).

According to an embodiment, the instructions can cause the wearable electronic device to magnify the image corresponding to the external electronic device and display the magnified image on the VR screen.

According to an embodiment, the external electronic device may be a foldable device or a rollable device.

According to an embodiment, the instructions can cause the wearable electronic device to obtain the image corresponding to the external electronic device included in the image obtained through the camera, based on detecting unfolding of the external electronic device and display the image corresponding to the external electronic device on the VR screen.

According to an embodiment, the instructions can cause the wearable electronic device to display text corresponding to the selected key on the display based on the identified key information.

According to an embodiment, when the external electronic device is not included in the image obtained through the camera according to rotation of the wearable electronic device after information is obtained through the code image, the at least one processor may display a virtual keyboard on the display.

According to an embodiment, the instructions can cause the wearable electronic device to display text corresponding to the selected key on the display based on the identified key information.

According to an embodiment, the instructions can cause the wearable electronic device to obtain position information about the plurality of keys included in the keyboard, based on the code image and identify the key information corresponding to the selected key by further considering a position of the color indicator.

According to an embodiment, the instructions can cause the wearable electronic device to identify the key information corresponding to the selected key based on the color of the color indicator displayed at a position unrelated to the position of the selected key on the external electronic device.

According to an embodiment, each time the color indicator is displayed on the external electronic device, the position where the color indicator is displayed on the external electronic device may change randomly.

According to an embodiment, the wearable electronic device may further include a communication module (e.g., the communication module 190 of FIG. 1).

According to an embodiment, the communication module may be in a communication disconnection state with the external electronic device.

According to an embodiment, a method for controlling a wearable electronic device may include obtaining, from an image captured by a camera of the wearable electronic device, a code image corresponding to a keyboard displayed on an external electronic device.

According to an embodiment, the method may include obtaining key information corresponding to each of a plurality of keys included in the keyboard, based on the code image.

According to an embodiment, the method may include, in response to detecting a selection of a key from the keyboard, based on the image captured by the camera, identifying key information corresponding to the selected key.

According to an embodiment, the method may include performing an operation corresponding to the selected key based on the identified key information.

According to an embodiment, the key information can include a plurality of key code values and a plurality of pieces of color information, corresponding to the plurality of keys, respectively. The method can further include identifying a color of a color indicator displayed on the external electronic device, from the image captured by the camera, identifying color information corresponding to the identified color among the plurality of pieces of color information, identifying a key code value corresponding to the identified color information, and performing an operation corresponding to the identified key code value. The color indicator can correspond to the selected key.

According to an embodiment, the method can include acquiring an image corresponding to the external electronic device included in the image captured by the camera, while displaying a virtual reality screen on the display and displaying the image corresponding to the external electronic device on the virtual reality screen.

According to an embodiment, the key information may include a plurality of key code values and a plurality of pieces of color information, corresponding to the plurality of keys, respectively.

According to an embodiment, identifying the key information may include identifying a color of a color indicator displayed on the external electronic device, through the image obtained through the camera.

According to an embodiment, identifying the key information may include identifying color information corresponding to the identified color among the plurality of pieces of color information.

According to an embodiment, identifying the key information may include identifying a key code value corresponding to the identified color information.

According to an embodiment, performing the operation corresponding to the selected key may include performing an operation corresponding to the identified key code value.

According to an embodiment, the color indicator may correspond to the selected key.

According to an embodiment, the method may further include obtaining an image corresponding to the external electronic device included in the image obtained through the camera, while displaying a VR screen on the display.

According to an embodiment, the method may further include displaying the image corresponding to the external electronic device on the VR screen.

According to an embodiment, the method may further include magnifying the image corresponding to the external electronic device.

According to an embodiment, the method may further include displaying the magnified image on the VR screen.

According to an embodiment, the external electronic device may be a foldable device or a rollable device.

According to an embodiment, the method may further include detecting unfolding of the external electronic device and obtaining the image corresponding to the external electronic device included in the image captured by the camera, based on detecting unfolding of the external electronic device. The image corresponding to the external electronic device can be displayed on the virtual reality screen

According to an embodiment, the method may further include displaying text corresponding to the selected key on the display based on the identified key information.

According to an embodiment, the method may further include, when the external electronic device is not included in the image obtained through the camera according to rotation of the electronic device after information is obtained through the code image, displaying a virtual keyboard on the display.

According to an embodiment, the method may further include obtaining position information about the plurality of keys included in the keyboard, based on the code image and identifying the key information corresponding to the selected key based on a position of the color indicator.

According to an embodiment, the method can include identifying the key information corresponding to the selected key based on the color of the color indicator displayed at a position unrelated to the position of the selected key on the external electronic device.

According to an embodiment, each time the color indicator is displayed on the external electronic device, the position where the color indicator is displayed on the external electronic device may change randomly.

According to an embodiment, a communication module of the wearable electronic device may be in a communication disconnection state with the external electronic device.

According to an embodiment, a computer program product can include a non-transitory computer-readable storage medium storing instructions configured to be executed by at least one processor of a wearable electronic device to perform a plurality of operations to obtain, from an image captured by a camera of the wearable electronic device, a code image corresponding to a keyboard displayed on an external electronic device and obtain key information corresponding to each of a plurality of keys included in the keyboard, based on the code image.

According to an embodiment, the operations can include, in response to detecting a selection of a key from the keyboard, based on the image captured by the camera, identifying key information corresponding to the selected key.

According to an embodiment, the operations can include performing an operation corresponding to the selected key based on the identified key information.

According to an embodiment, the key information may include a plurality of key code values and a plurality of pieces of color information, corresponding to the plurality of keys, respectively.

According to an embodiment, the operations can include identifying a color of a color indicator displayed on the external electronic device, through the image captured by the camera, identifying color information corresponding to the identified color among the plurality of pieces of color information, identifying a key code value corresponding to the identified color information, and performing an operation corresponding to the identified key code value.

According to an embodiment, the color indicator may correspond to the selected key.

According to an embodiment, the operations can include obtaining an image corresponding to the external electronic device included in the image obtained through the camera, while displaying a VR screen on the display.

According to an embodiment, the operations can include displaying the image corresponding to the external electronic device on the VR screen.

According to an embodiment, the operations can include magnifying the image corresponding to the external electronic device.

According to an embodiment, the operations can include displaying the magnified image on the VR screen.

According to an embodiment, the external electronic device may be a foldable device or a rollable device.

According to an embodiment, the operations can include obtaining the image corresponding to the external electronic device included in the image captured by the camera, based on detecting unfolding of the external electronic device.

According to an embodiment, the operations can include displaying the image corresponding to the external electronic device on the VR screen.

According to an embodiment, the operations can include displaying text corresponding to the selected key on the display based on the identified key information.

According to an embodiment, the operations can include when the external electronic device is not included in the image obtained through the camera according to rotation of the electronic device after information is obtained through the code image, displaying a virtual keyboard on the display.

According to an embodiment, the operations can include obtaining position information about the plurality of keys included in the keyboard, based on the code image.

According to an embodiment, the operations can include identifying the key information corresponding to the selected key by further considering a position of the color indicator.

According to an embodiment, the operations can include identifying the key information corresponding to the selected key based on the color of the color indicator displayed at a position unrelated to the position of the selected key on the external electronic device.

According to an embodiment, each time the color indicator is displayed on the external electronic device, the position where the color indicator can be displayed on the external electronic device may change randomly.

According to an embodiment, the wearable electronic device may further include a communication module.

According to an embodiment, the communication module may be in a communication disconnection state with the external electronic device.

The electronic device according to embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B”, “at least one of A and B”, “at least one of A or B”, “A, B, or C”, “at least one of A, B, and C”, and “at least one of A, B, or C”, may include any one of, or all possible combinations of the items enumerated together in a corresponding one of the phrases. As used herein, such terms as “1st” and “2nd”, or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., wiredly), wirelessly, or via a third element.

As used in connection with embodiments of the disclosure, the term “module” may include a unit implemented in hardware, software, or firmware, and may interchangeably be used with other terms, for example, logic, logic block, part, or circuitry. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to embodiments, each component (e.g., a module or a program) of the above-described components may include a single entity or multiple entities, and some of the multiple entities may be separately disposed in different components. According to embodiments, one or more of the above-described components may be omitted, or one or more other components may be added. Alternatively or additionally, a plurality of components (e.g., modules or programs) may be integrated into a single component. In such a case, according to embodiments, the integrated component may still perform one or more functions of each of the plurality of components in the same or similar manner as they are performed by a corresponding one of the plurality of components before the integration. According to embodiments, operations performed by the module, the program, or another component may be carried out sequentially, in parallel, repeatedly, or heuristically, or one or more of the operations may be executed in a different order or omitted, or one or more other operations may be added.

What is claimed is:

1. A wearable electronic device comprising:
a camera;
a display;
a memory; and
at least one processor including processing circuitry and operatively connected to the camera, the display, and the memory,
wherein the memory stores instructions that, when executed by the at least one processor, individually or collectively, cause the wearable electronic device to:
obtain, from an image captured by the camera, a code image corresponding to a keyboard displayed on an external electronic device;
obtain key information corresponding to each of a plurality of keys included in the keyboard, based on the code image;
in response to detecting a selection of a key from the keyboard, based on the image captured by the camera, identify key information corresponding to the selected key; and
perform an operation corresponding to the selected key based on the identified key information.

2. The wearable electronic device of claim 1, wherein the key information includes a plurality of key code values and a plurality of pieces of color information, corresponding to the plurality of keys, respectively.

3. The wearable electronic device of claim 2, wherein the instructions cause the wearable electronic device to:
identify a color of a color indicator displayed on the external electronic device, from the image captured by the camera;
identify color information corresponding to the identified color among the plurality of pieces of color information;
identify a key code value corresponding to the identified color information; and
perform an operation corresponding to the identified key code value,
wherein the color indicator corresponds to the selected key.

4. The wearable electronic device of claim 1, wherein the instructions cause the wearable electronic device to:
obtain an image corresponding to the external electronic device included in the image captured by the camera, while displaying a virtual reality screen through the display; and
display the image corresponding to the external electronic device on the virtual reality screen.

5. The wearable electronic device of claim 4, wherein the instructions cause the electronic device to:
magnify the image corresponding to the external electronic device; and
display the magnified image on the virtual reality screen.

6. The wearable electronic device of claim 4, wherein the external electronic device includes a foldable device or a rollable device, and
wherein the instructions cause the wearable electronic device to:
detect unfolding of the external electronic device;
obtain the image corresponding to the external electronic device included in the image captured by the camera, based on detecting of the unfolding of the external electronic device; and
display the image corresponding to the external electronic device on the virtual reality screen.

7. The wearable electronic device of claim 1, wherein the instructions cause the wearable electronic device to:
display text corresponding to the selected key on the display based on the identified key information.

8. The wearable electronic device of claim 3, wherein the instructions cause the wearable electronic device to:
obtain position information of the plurality of keys included in the keyboard, based on the code image; and
identify the key information corresponding to the selected key based on a position of the color indicator.

9. The wearable electronic device of claim 3, wherein the instructions cause the wearable electronic device to:
identify the key information corresponding to the selected key based on the color of the color indicator displayed at a position unrelated to the position of the selected key on the external electronic device.

10. The wearable electronic device of claim 9, wherein the position of the color indicator on the external electronic device changes randomly each time the color indicator is displayed.

11. The wearable electronic device of claim 1, further comprising a communication circuit, wherein the communication circuit is in a communication disconnection state with the external electronic device.

12. A method for controlling a wearable electronic device, comprising:
obtaining, from an image captured by a camera of the wearable electronic device, a code image corresponding to a keyboard displayed on an external electronic device;
obtaining key information corresponding to each of a plurality of keys included in the keyboard, based on the code image;
in response to detecting a selection of a key from the keyboard, based on the image captured by the camera, identifying key information corresponding to the selected key; and
performing an operation corresponding to the selected key based on the identified key information.

13. The method of claim 12, wherein the key information includes a plurality of key code values and a plurality of pieces of color information, corresponding to the plurality of keys, respectively, and further comprising:
identifying a color of a color indicator displayed on the external electronic device, from the image captured by the camera;
identifying color information corresponding to the identified color among the plurality of pieces of color information;
identifying a key code value corresponding to the identified color information; and
performing an operation corresponding to the identified key code value,
wherein the color indicator corresponds to the selected key.

14. The method of claim 12, further comprising:
acquiring an image corresponding to the external electronic device included in the image captured by the camera, while displaying a virtual reality screen on the display; and
displaying the image corresponding to the external electronic device on the virtual reality screen.

15. The method of claim 14, wherein the external electronic device includes a foldable device or a rollable device, and further comprising:
detecting unfolding of the external electronic device;
obtaining the image corresponding to the external electronic device included in the image captured by the camera, based on detecting of the unfolding of the external electronic device; and
displaying the image corresponding to the external electronic device on the virtual reality screen.

16. The method of claim 13, further comprising:
obtaining position information of the plurality of keys included in the keyboard, based on the code image; and
identifying the key information corresponding to the selected key based on a position of the color indicator.

17. The method of claim 13, further comprising:
identifying the key information corresponding to the selected key based on the color of the color indicator displayed at a position unrelated to the position of the selected key on the external electronic device.

18. The method of claim 12, wherein the wearable electronic device is in a communication disconnection state with the external electronic device.

19. A computer program product comprising a non-transitory computer-readable storage medium storing instructions configured to be executed by at least one processor of a wearable electronic device to perform a plurality of operations comprising:
obtaining, from an image captured by a camera of the wearable electronic device, a code image corresponding to a keyboard displayed on an external electronic device;
obtaining key information corresponding to each of a plurality of keys included in the keyboard, based on the code image;
in response to detecting a selection of a key from the keyboard, based on the image captured by the camera, identifying key information corresponding to the selected key; and
performing an operation corresponding to the selected key based on the identified key information.

20. The computer program product of claim 19, wherein the key information includes a plurality of key code values and a plurality of pieces of color information, corresponding to the plurality of keys, respectively, and the operations further comprising:
identifying a color of a color indicator displayed on the external electronic device, from the image captured by the camera;
identifying color information corresponding to the identified color among the plurality of pieces of color information;
identifying a key code value corresponding to the identified color information; and
performing an operation corresponding to the identified key code value,
wherein the color indicator corresponds to the selected key.
